(19) United States
(12) Patent Application Publication
(10) Pub. No.: US 2024/0310816 A1
(43) Pub. Date: Sep. 19, 2024

(54) 3D Production Machine with Continuous Process, Calibration and Self-Corrrection

(71) Applicants: Rylan Harry Grayston, Gorlitz (CA); Braeden Daniel Leislar, Saskatoon (CA); Joshua Grasby, Saskatoon (CA)

(72) Inventors: Rylan Harry Grayston, Gorlitz (CA); Braeden Daniel Leislar, Saskatoon (CA); Joshua Grasby, Saskatoon (CA)

(21) Appl. No.: 18/592,518

(22) Filed: Mar. 1, 2024

Related U.S. Application Data
(60) Provisional application No. 63/478,156, filed on Jan. 1, 2023.

(51) Int. Cl. G05B 19/4099

(52) U.S. Cl. CPC G05B 19/4099; G05B 2219/49007

(57) ABSTRACT

The invention herein disclosed is 3D production system combining both additive and subtractive action tools, continuous processing, continuous calibration monitoring and adjustment, a certified gauge block, and identification of opportunities to alter process flow and shorten time while self-correcting.

### TECHNICAL FIELD

The invention is a system for 3D production that incorporates continuous operation, calibration and self-correction.

### BACKGROUND OF INVENTION

Today's 3D production machines, also known as 3D printers, are playing a key role by increasing the efficiency of prototype production. However, these 3D production machines are operative to produce components based on a tool-path planning programs and G-code numerical-control algorithms.

If a part requires more than one type of constituent—droplets, or fiber, or metals—it becomes a multi-part process involving different machines, programs, and added opportunities for failure.

As 3D production machines proceed in successive substance deposition, usually the feedback metrics are based on encoders on motors rather than measuring the actual part visually. And, those machines that do use visual results testing often do so at the end rather than continuously throughout the production process.

If testing is done at the end, and a part has a problem, it is often discarded and the process begins anew. When that happens, costs of materials increase and time-to-production increases.

What is missing are systems that can do the entire production, including a mix of materials, while continuously monitoring results, in near-real time, and often being able to take corrective action that obviates the need to discard and start over.

### BRIEF DESCRIPTION OF INVENTION

The invention herein disclosed is a 3D production system comprising sophisticated computer control and a production machine with multi-axis-rotation. In addition, it supports continuous scanning of the production object, plus an opportunistic element of action-tool deployment. And, it makes novel use of a certified gauge block for accurate measurement and calibration support, plus a combination both additive (deposition) and subtractive (ablation) action tools that support greater efficiency and self-correction.

### BRIEF DESCRIPTION OF DRAWINGS

FIG. 1 shows an embodiment of the invention.

FIG. 2 shows the embodiment of FIG. 1 with more functional detail.

FIG. 3 shows a open-top view of an embodiment of the 3D production machine subsystem.

FIG. 4 illustrates an embodiment of the multi-axis-rotation subsystem of the 3D production machine subsystem.

FIG. 5 shows another view of the multi-axis-rotation subsystem FIG. 6 is an exemplary illustration of production of a 3D letter “P.”

FIG. 7 shows a division of the P into different build-volume portions having different characteristics.

FIG. 8 shows how different droplets deposited may or may not fall within the P's intended build volumes.

FIG. 9 shows how the system opportunistically processes, on the fly, those depositions that are within the P's build volume.

FIG. 10 illustrates further processing of the production to the letter P.

FIG. 11 shows how the light direction plays a part in reducing error.

FIG. 12 illustrates how the depositions are tailored to the build volume positions.

FIG. 13 is a further illustration of the P production process.

FIG. 14 is a further illustration of the P production process.

FIG. 15 shows a certified gauge block which is used in the 3D production machine subsystem.

FIG. 16 provides more detail about use of the gauge block in the P production process.

FIG. 17 illustrates how the rotating gauge block is used during P production.

### DETAILED DESCRIPTION OF INVENTION

The invention adds novel structures and functions to 3D production machine system technology. The objective was to add both additive and subtractive action tools to a single 3D production machine along with a certified gauge-block that supports more accurate results measurement and continuous calibration, and the ability to stream the actions in step with scanning and testing results to enable a significant degree of self-correcting actions as errors are detected in an object's build volume results.

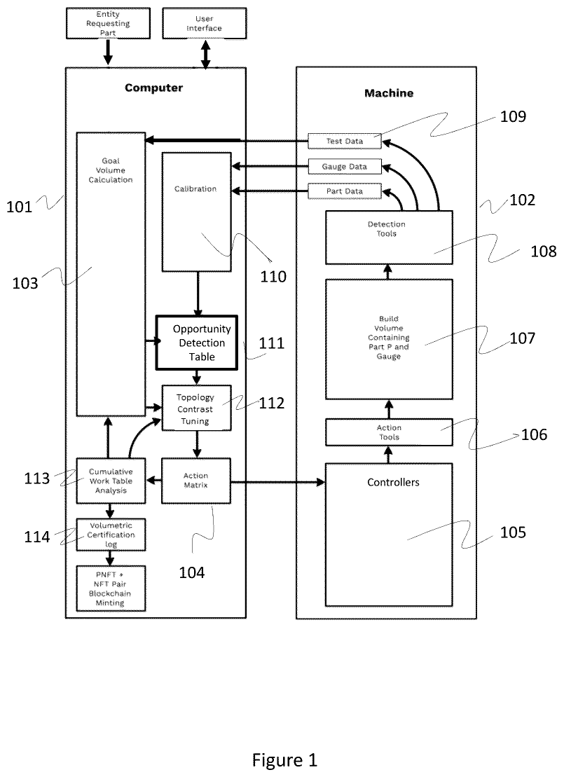

FIG. 1 shows an embodiment of the invention showing the computer subsystem and the 3D production machine subsystem as well as providing a view of process flow. As shown, the system comprises a computer subsystem (101) and a 3D production machine subsystem (102). The process flow begins with a goal volume calculation (103) which contributes to an action-matrix process (104) that are all done within the computer subsystem. The action-matrix process essentially controls the 3D production machine subsystem by sending data to the 3D machine's controllers subsystem (105). The controllers then control the action tools, 106 (deposition and ablation subsystems), which begin operating in the build volume space (107). As production proceeds, detection tools (108) provide continuous metrics comprising test, gauge and part data. Test data (109) is fed to the goal volume calculation process. And gauge and part data is fed to the calibration process (110). The calibration process provides data, along with the goal volume calculation process, to the opportunity detection table (111), which completes the loop by sending data to the action-matrix process.

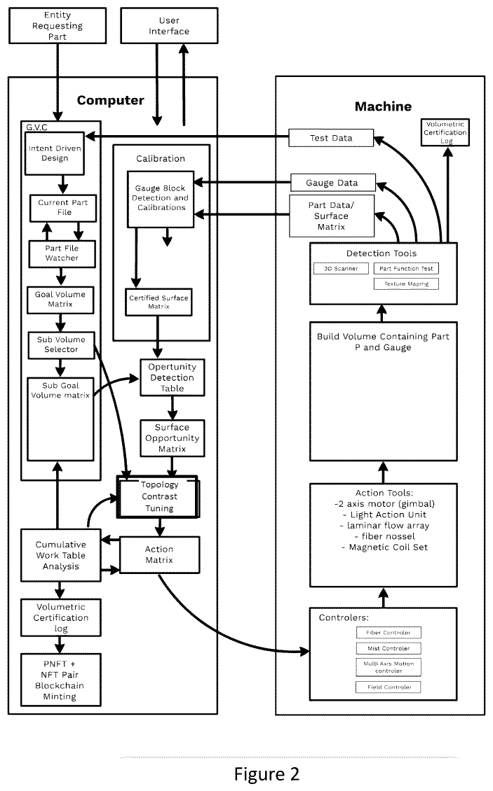

FIG. 2 fleshes out the system embodiment by including more interim processes to those of FIG. 1. The objective is to refine and converge on closed-loop operation control so as to enable a continuous process, augmented by opportunistic modifications, with the overall goal of producing a part that meets specification requests in a single production cycle.

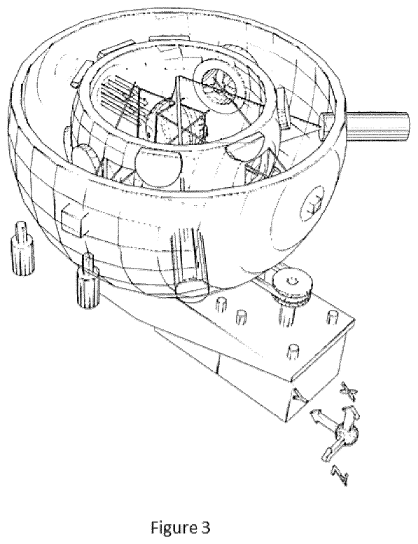

FIG. 3 shows an embodiment of the 3D production machine subsystem with the top removed to expose the inner structures.

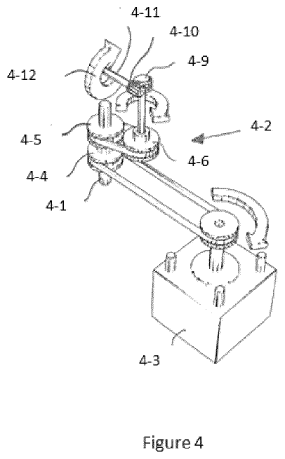

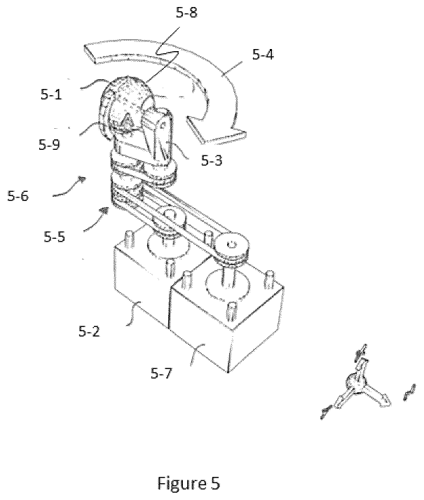

FIG. 4 zeros in on the multi-axis-rotation subsystem, showing its drivetrain and motor (4-3), and drive pulley (4-4) which is rigidly affixed to pulley 4-5.

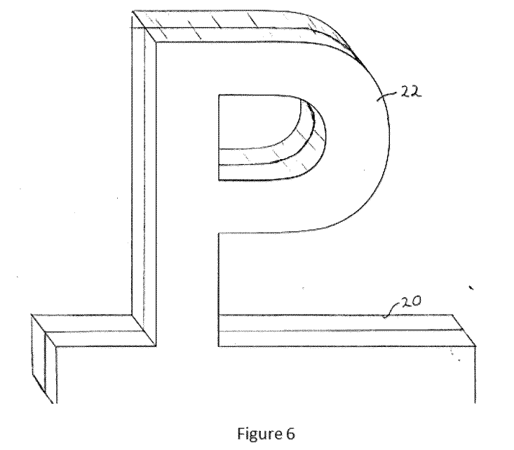

Pulleys 4.5 and 4.6 form a double pulley which spins freely and upon shaft 4.1. Pulley 4.5 drives pulley 4.6 which in turn drives worm gear 4.9. Worm gear 4.9 drives spur gear 4-10 which drives shaft 4-11 as depicted by arrow 4-12. Therefore motor 4-3 drives shaft 4-11 about the shaft's axis of rotation. FIG. 5 shows how drivetrains 5-5 and 5-6 work together allowing motor 5-7 to control the off-axis rotation of shaft 5-8 via the rotation of trunnion 5-3 as depicted by arrow 5-4 while at the same time allowing motor 5-7 to control the on-axis rotation of shaft 5-8 as depicted by arrow 5-9.

FIGS. 6-16 show an exemplary flow of actions required to produce a 3D letter “P.” In FIG. 6, shows a base (20) and goal volume (22) to be produced by the 3D production machine subsystem.

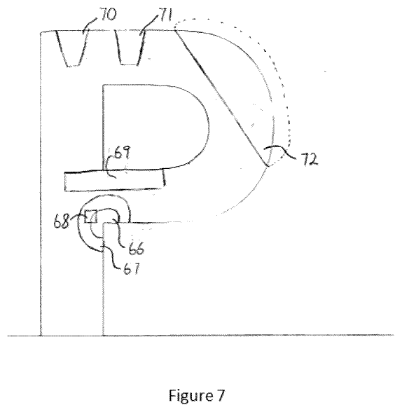

FIG. 7 shows how the goal volume of FIG. 6 has been organized into sub-volumes with different characteristics. Sub-volume 66 is a high-accuracy volume wherein a sharp corner is to be produced. Sub-volume 67 is a buffer sub-volume acting as a transition to the higher-accuracy sub-volume (66). Sub-volume 68 marks where a very small part will be produced within a larger part. Sub-volume 69 is to be fiber reinforced to provide part strength. Sub-volumes 70 and 71 are not to be filled until a part is placed within these voids. And, sub-volume 72 marks the beginning of a gradient material change.

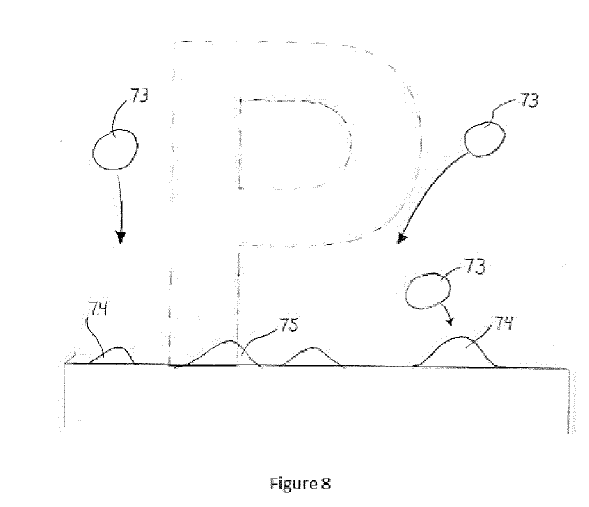

As shown in FIG. 8, the mist particles (73) fall all over the base. Some (74) fall outside of the goal volume. Some (75) fall within or partially within the goal volume.

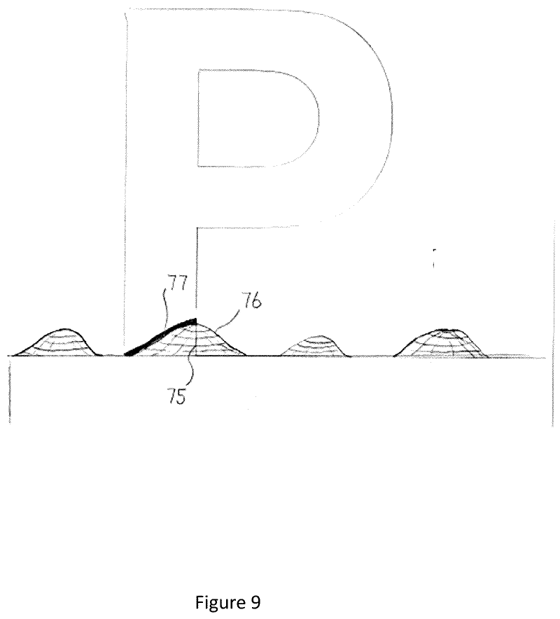

As shown in FIG. 9, mist particle (75) straddles the goal volume, as determined by the invention system's scanning and checking. The portion of the particle that is outside the goal volume, shown as 76, does not represent an opportunity whereas the portion 77 that is within the goal volume and will be marked for as an opportunity for further material.

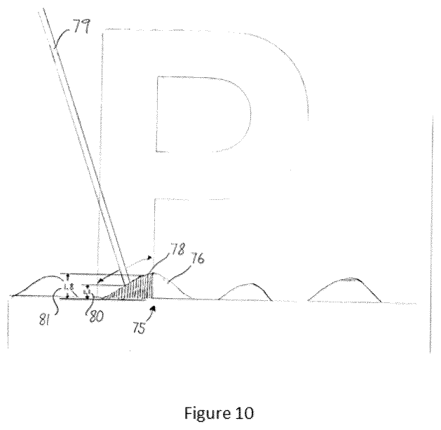

In FIG. 10, following on the findings illustrated in FIG. 9, a light action tool illuminates and hardens the material of droplet 75 that is within the goal volume, portion 78, whereas the portion that is outside the goal volume (76) is allowed to remain in liquid state. Laser power is dependent upon thickness. Thus, more power is required to harden the thicker portion (81) than for the thinner portion (80).

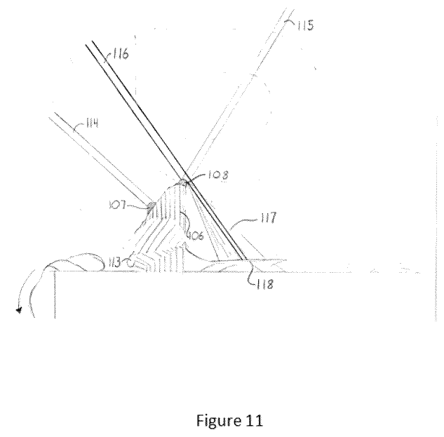

In FIG. 11, the beam angles 114 and 115 used to solidify droplets 107 and 108. These beams are perpendicular to the surface of the droplets (106). Beam 116, for example, could produce beam 117 which would harden the portion of the droplet (118) that is outside the goal volume.

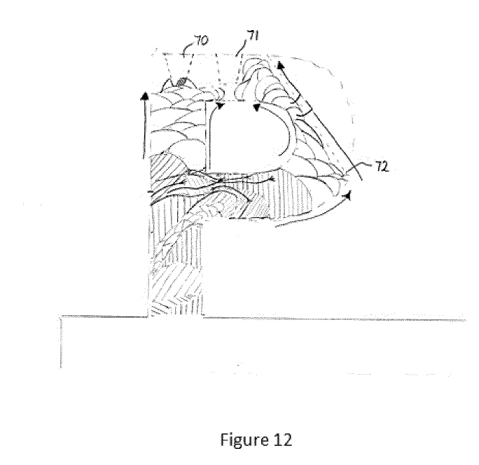

In FIG. 12, one sees that the repeated actions lead to build up of parts in the general directions shown by the arrows because sub-volumes 70, 71 and 72 limit the direction of growth consistent with the goal-volume intent.

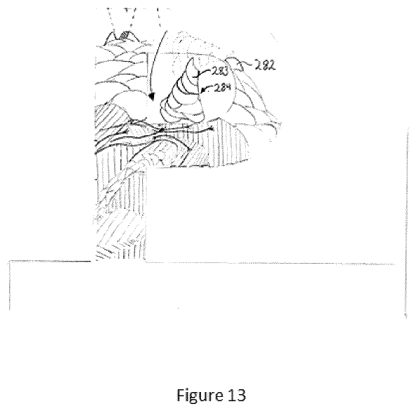

In FIG. 13, a portion of the P (284) has broken off including particle 283. This leaves particle 282 as an opportunity for further action while 283 is no longer in play.

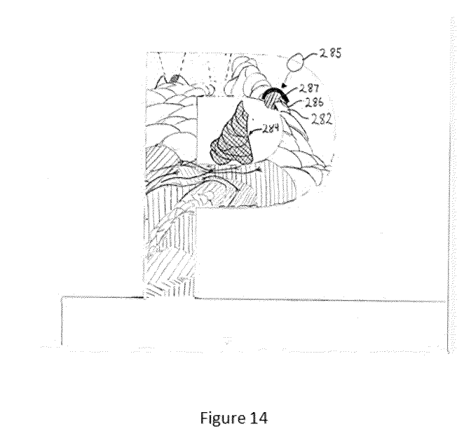

In FIG. 14, a droplet (285) lands on particle 282 forming droplet 286. When droplet 286's surface is scanned (287) it is seen as opportunity.

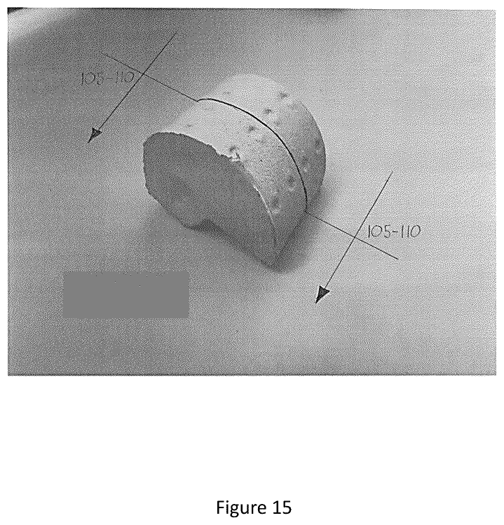

FIGS. 15-19 describe the gauge block that is part of the 3D product machine subsystem.

FIG. 15 shows the structure of the gauge block.

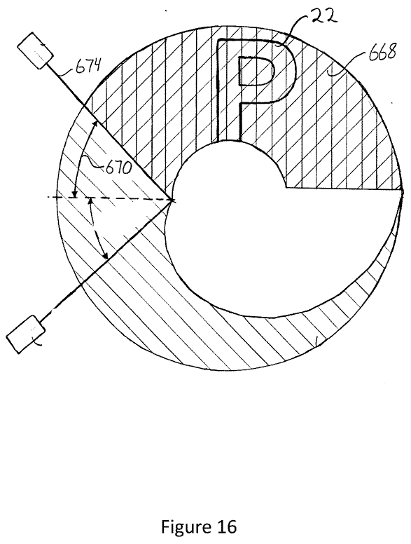

FIG. 16 shows how the 3D letter P (22) fits within the hatched area (668). The hatched area is defined by the beam angle (670) and volume of the gauge. Hatched area 668 is the area upon which all beam angles are compared. As the part is built upon the gauge itself both the part and the shell gauge rotate together providing that every rotation the gauge is checked and the work on the part compared to the gauge.

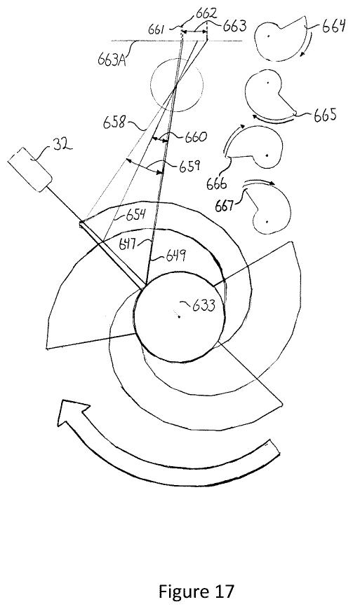

FIG. 17 shows a shell gauge 633 which is a new type of gauge block specifically designed for the 3D production machine subsystem the embodiment includes a tapered and indexed hole allowing the gauge to be placed in the machine on multi-axis-rotation subsystem shaft. A portion of the gauge's surface 635 has a constant radius, while another portion of the gauge 636 has a radius which grows linearly with the rotation. In other words the radius is integrated over the rotation. Divets or other markings 637-642 may be present in the surface of the gauge to assist in identification and positional alignment. The purpose of the gauge is to provide a certified surface which moves across all possible points on the work planes of both the scanner and illuminator so that all beams can be aligned to each other and to the gauge, and to the part being produced. This alignment can constantly be monitored logged and corrected via direct comparison in between each finite scan and action in the modification of the part being created.

The drawings and descriptions are exemplary and should not be read as limiting the scope of the patent. The system can be implemented as separate main computer and 3D production machine subsystems, or they can be combined into a single system. The key points of novelty are the use of the gauge block upon which the object is build, and being rotated in multi-axis rotation. In addition, the combination of additive and subtractive action tools enables both to be used in a single production process session with a single 3D production machine. Further, the ability to scan and measure process results, and identify opportunities for a change in process sequence, on the fly, enables self-correction and higher efficiency. Combining a variety of additive action tools for droplet, fiber and metal particle deposition adds versatility to the production end product.

What is claimed is:

1. A 3D production system comprising:
a 3D production machine subsystem;
a computer subsystem;
the 3D production machine subsystem comprises:
a multi-axis-rotation subsystem;
at least one substance deposition subsystem;
at least one 3D scanning subsystem;
at least one laser ablation subsystem; and
a certified gauge-block subsystem
the computer subsystem comprises:
at least one 3D production machine subsystem closed-loop control program; and
at least one calibration program.

2. A system claim as in claim 1 wherein:
the at least one substance deposition subsystem is operative to deposit droplets.

3. A system claim as in claim 1 wherein:
the at least one substance deposition subsystem is operative to deposit fibers.

4. A system claim as in claim 1 wherein:
the at least one substance deposition subsystem is operative to deposit metallic particles.

5. A system claim as in claim 1 wherein:
The multi-axis-rotation subsystem is operative to a build volume such that every area of the build volume is exposed to potential depositions from every substance deposition subsystem and every laser ablation subsystem.

6. A system claim as in claim 1 wherein:
the certified gauge block continuously rotates and supports precise build-volume object measurements and calibration enabling near-real-time, voxel-level results testing and self-corrective action.

7. A system claim as in claim 1 wherein:
the at least one 3D production machine subsystem closed-loop control program is operative to control rotation.

8. A system claim as in claim 1 wherein:
the at least one 3D production machine subsystem closed-loop control program is operative to control deposition.

9. A system claim as in claim 1 wherein:
the at least one 3D production machine subsystem closed-loop control program is operative to control interim results testing.

10. A system claim as in claim 1 wherein:
the at least one 3D production machine subsystem closed-loop control program is operative to control corrective actions in response to near-real-time results testing.

11. A system claim as in claim 1 wherein:
the at least one calibration program is operative to control recalibration operations in response to gauge-block comparison metrics.

12. A method of use comprising:
calculating goal volume based on part request that is input to a computer subsystem;
creating an action matrix by the computer subsystem;
sending action matrix-derived control directives to controller subsystem in a 3D production machine subsystem;
controlling deposition and ablation action tools in the 3D production machine subsystem by the controller subsystem in the computer subsystem;
detecting results of action-tool actions in the 3D production machine subsystem;
collecting test data based on detection in the 3D production machine subsystem;
feeding test data to goal volume calculating portion in the computer subsystem;
feeding gauge data to a calibration-program process in the computer subsystem; and
feeding part-results data to a calibration-program process in the computer subsystem.

13. A method claim as in claim 12 further comprising:
passing goal-volume calculation data to an opportunity detection table in the computer subsystem;
passing the goal-volume calculation data and the opportunity detection table data to a topology contrast tuning program process in the computer subsystem;
passing topology contrast tuning results to a cumulative worktable analysis process in the computer subsystem; and
feeding back the output of the cumulative worktable analysis process to the goal volume calculation process in the computer subsystem.

14. A method claim as in claim 13 further comprising:
sending data from the cumulative worktable analysis process to volumetric certification log in the computer subsystem.
